(19) United States
(12) Patent Application Publication
(10) Pub. No.: US 2015/0100866 A1
(43) Pub. Date: Apr. 9, 2015

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Yoji KUDO, Kanagawa (JP)

(73) Assignee: FUJI XEROX CO., LTD., Tokyo (JP)

(21) Appl. No.: 14/271,611

(22) Filed: May 7, 2014

(30) Foreign Application Priority Data
Oct. 7, 2013 (JP) 2013-210010

(51) Int. Cl. G06F 17/21

(52) U.S. Cl. CPC G06F 17/211
USPC 715/201

(57) ABSTRACT

An information processing apparatus includes a memory, a display, a transmission unit, a reception unit, and a display operation unit. The memory stores data including an identifier of another apparatus or an identifier of a user of the other apparatus. The display displays an image based on the data. The transmission unit transmits, in a case where the data is specified as a display target, information related to a display operation to be performed on the data to the other apparatus identified by the identifier of the other apparatus or by the identifier of the user of the other apparatus. The reception unit receives, from the other apparatus, an operation command corresponding to a display operation to be performed on the data. The display operation unit operates the displayed image based on the data, in accordance with the received operation command.

### CROSS-REFERENCE TO RELATED APPLICATIONS

This application is based on and claims priority under 35 USC 119 from Japanese Patent Application No. 2013-210010 filed Oct. 7, 2013.

### BACKGROUND

(i) Technical Field

The present invention relates to an information processing apparatus, an information processing system, and a non-transitory computer readable medium.

(ii) Related Art

There have been proposed technologies that enable remote operation of devices connected to each other via a network.

### SUMMARY

According to an aspect of the invention, there is provided an information processing apparatus including a memory, a display, a transmission unit, a reception unit, and a display operation unit. The memory stores data including an identifier of another apparatus or an identifier of a user of the other apparatus. The display displays an image based on the data. The transmission unit transmits, in a case where the data is specified as a display target, information related to a display operation to be performed on the data to the other apparatus identified by the identifier of the other apparatus or by the identifier of the user of the other apparatus. The reception unit receives, from the other apparatus, an operation command corresponding to a display operation to be performed on the data. The display operation unit operates the displayed image based on the data, in accordance with the received operation command.

### BRIEF DESCRIPTION OF THE DRAWINGS

An exemplary embodiment of the present invention will be described in detail based on the following figures, wherein:

FIG. 1 is a block diagram illustrating an example of an information processing system according to an exemplary embodiment of the present invention;

FIG. 2A is a schematic diagram illustrating an example of the structure of image data and FIG. 2B is a schematic diagram illustrating an example of the structure of remote control user interface (UI) information;

FIG. 3 is a flowchart illustrating an example of an operation performed by an information processing apparatus according to the exemplary embodiment; and

FIG. 4 illustrates an example of an order table.

### DETAILED DESCRIPTION

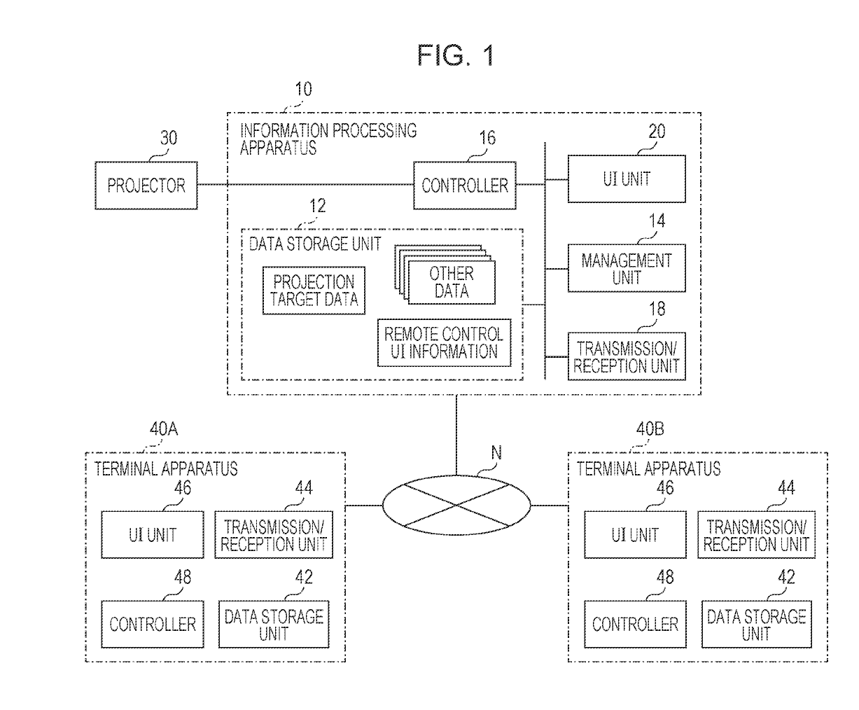

FIG. 1 illustrates an example of an information processing system according to an exemplary embodiment of the present invention. An information processing apparatus 10 according to the exemplary embodiment is connected to, for example, a projector 30 configured to project an image.

The information processing apparatus 10 controls the projection operation. The information processing apparatus 10 and terminal apparatuses 40A and 40B are directly connected to one another via a network N, and transmit and receive data to and from one another. For example, the information processing apparatus 10 and the terminal apparatuses 40A and 40B are connected to one another using the pear to pear method, and transmit and receive data to and from one another. Note that although FIG. 1 illustrates the terminal apparatuses 40A and 40B, one terminal apparatus or three or more terminal apparatuses may be directly connected to the information processing apparatus 10 via the network N. Because the information processing apparatus 10 and the terminal apparatuses 40A and 40B are directly connected to one another in this manner, the information processing apparatus 10 and the terminal apparatuses 40A and 40B are permitted to access a shared data storage unit.

The information processing apparatus 10 includes a data storage unit 12, a management unit 14, a controller 16, a transmission/reception unit 18, and a user interface unit (UI unit) 20.

The data storage unit 12 stores data transmitted from the terminal apparatuses 40A and 40B. For example, the data storage unit 12 stores image data (also referred to as projection-target image data) to be projected by the projector 30. Data transmitted from the terminal apparatuses 40A and 40B is stored in a data storage area (shared area) of the data storage unit 12, the data storage area (shared area) being an area which the terminal apparatuses 40A and 40B are permitted to access. In this way, the terminal apparatuses 40A and 40B are permitted to access the data stored in the shared area of the data storage unit 12. For example, projection-target image data is transmitted from the terminal apparatuses 40A and 40B to the information processing apparatus 10 and is stored in the shared area of the data storage unit 12.

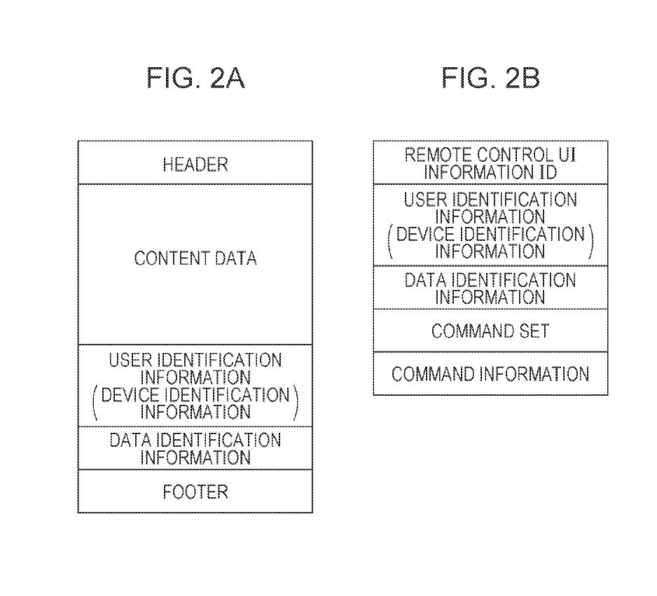

Each image data is attached with data identification information that identifies the image data, and also with at least one of user identification information and device identification information. The user identification information is information (e.g., name or user ID) that identifies a provider of image data. The device identification information is information (e.g., device name or device ID) that identifies the terminal apparatus owned by the data provider (or in which the account of the data provider is set). FIG. 2A illustrates an example of the structure of image data. Image data includes content data representing image content, user identification information (or/and device identification information), and data identification information.

The data storage unit 12 also stores remote control user interface (UI) information which represents a remote control UI used to operate the projector 30 from the terminal apparatuses 40A and 40B. This remote control UI is a UI used to enter a command such as changing of the page of the image projected by the projector 30 at the terminal apparatuses 40A and 40B. FIG. 2B illustrates the structure of the remote control UI information. The remote control UI information includes a remote control UI information ID that identifies this remote control UI information, user identification information (or/and device identification information), data identification information of image data to be operated using this remote control UI, a set of commands permitted to be entered using the remote control UI, and command information (command).

The management unit 14 manages the shared area of the data storage unit 12, and stores data transmitted from the terminal apparatuses 40A and 40B in the shared area of the data storage unit 12.

The controller 16 controls transmission and reception of commands and data between the information processing apparatus 10 and the terminal apparatuses 40A and 40B. Also, the controller 16 controls the projector 30 so as to cause the projector 30 to project an image based on projection-target image data. For example, the controller 16 receives a command regarding an operation of the projector 30, and controls the projector 30 in accordance with the command.

In the case where image data stored in the data storage unit 12 is specified as a projection target of the projector 30, the controller 16 performs an operation process for operating the projector 30 from a terminal apparatus corresponding to user identification information (or device identification information) attached to the image data. For example, the controller 16 controls the transmission/reception unit 18 to transmit remote control UI information to the terminal apparatus.

The transmission/reception unit 18 transmits and receives commands and data via the network N. For example, the transmission/reception unit 18 receives image data and a command regarding an operation of the projector 30 from the terminal apparatuses 40A and 40B, and transmits remote control UI information to the terminal apparatuses 40A and 40B.

The UI unit 20 includes a display unit and an operation unit, and displays an image based on image data and accepts an operation from the user.

Next, the terminal apparatuses 40A and 40B will be described. The terminal apparatuses 40A and 40B each include a data storage unit 42, a transmission/reception unit 44, a UI unit 46, and a controller 48. The terminal apparatuses 40A and 40B may be, for example, personal computers or mobile terminal apparatuses, such as smartphones or mobile phones.

The data storage unit 42 stores various kinds of data. For example, the data storage unit 42 stores image data to be specified as a projection target of the projector 30. The transmission/reception unit 44 transmits and receives commands and data. The UI unit 46 includes a display unit and an operation unit, and displays images based on remote control UI information and image data and accepts an operation from the user. The controller 48 controls each unit.

The terminal apparatuses 40A and 40B are each associated with user identification information that identifies the user thereof (owner of the terminal apparatus or user whose account is set in the terminal apparatus). Also, the terminal apparatuses 40A and 40B are each associated with device identification information that identifies the terminal apparatus. The user identification information and the device identification information are stored, for example, in the data storage unit 42.

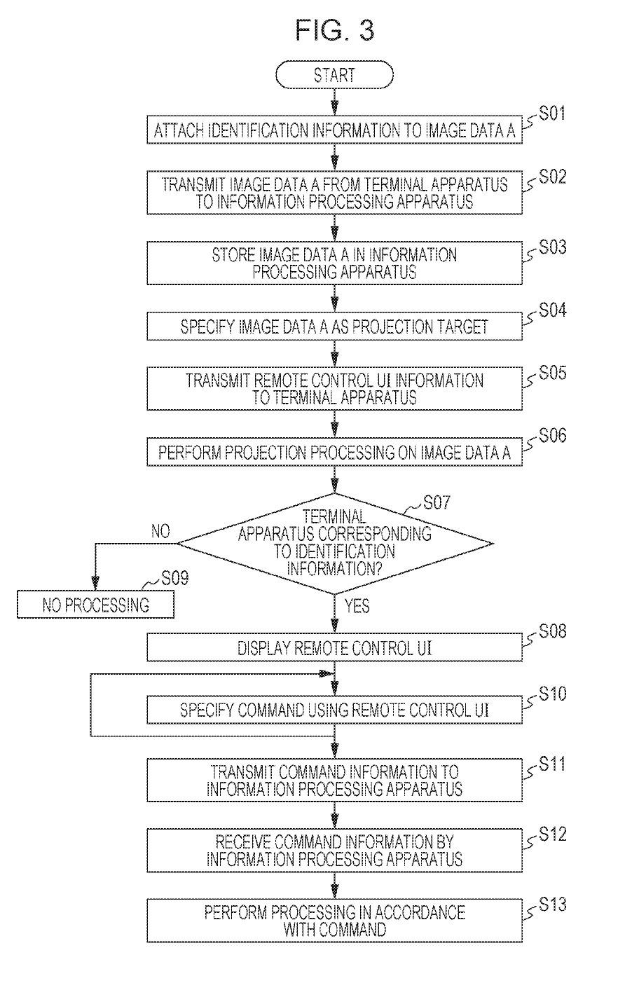

Referring next to the flowchart illustrated in FIG. 3, an example of an operation performed in the information processing system will be described. For example, it is assumed that the projector 30 is used at a meeting, a facilitator of the meeting operates the information processing apparatus 10, and the user of the terminal apparatus 40A provides image data and uses the projector 30. The user of the terminal apparatus 40A is hereinafter referred to as a “data provider”.

First, the user (data provider) of the terminal apparatus 40A operates the UI unit 46 of the terminal apparatus 40A so as to select image data A as a projection target from pieces of data stored in the terminal apparatus 40A, and attaches user identification information of the data provider to the image data A (S01). If the data provider enters a command to transmit the image data A, the transmission/reception unit 44 transmits the image data A to the information processing apparatus 10 (S02). The transmission/reception unit 18 of the information processing apparatus 10 receives the image data A from the terminal apparatus 40A, and the management unit 14 stores the image data A in the shared area of the data storage unit 12 (S03). For example, the image data A attached with the user identification information as illustrated in FIG. 2A is stored in the data storage unit 12. Note that the image data A may be attached with device identification information that identifies the terminal apparatus 40A.

Then, once the facilitator of the meeting operates the UI unit 20 of the information processing apparatus 10 so as to specify the image data A as the projection target of the projector 30 (S04), the transmission/reception unit 18 transmits remote control UI information under control of the controller 16 (S05). The controller 16 controls the projector 30 so as to cause the projector 30 to project an image based on the image data A (S06).

Now, a remote control UI information transmission process will be described in detail. For example, the controller 16 generates remote control UI information which includes the remote control UI information ID, the user identification information attached to the image data A (user identification information that identifies the user of the terminal apparatus 40A), the data identification information of the image data A, and the command set as illustrated in FIG. 2B. The transmission/reception unit 18 then transmits the generated remote control UI information. At this time, the transmission/reception unit 18 transmits the remote control UI information to both the terminal apparatuses 40A and 40B connected to the network N, in accordance with a broadcast method, for example. In the case where the image data A is attached with device identification information that identifies the terminal apparatus 40A, the controller 16 may include the device identification information in the remote control UI information.

If a terminal apparatus that has received the remote control UI information is the terminal apparatus corresponding to the user identification information included in the remote control UI information (YES in S07), the controller 48 of the terminal apparatus causes the UI unit 46 to display a remote control UI based on the remote control UI information (S08). This will be described in detail. The controller 48 of each of the terminal apparatuses 40A and 40B compares the user identification information included in the remote control UI information transmitted from the information processing apparatus 10 with the user identification information stored in the data storage unit 42 thereof. If the pieces of user identification information match, the controller 48 causes the UI unit 46 to display a remote control UI based on the remote control UI information (S08). For example, the remote control UI information includes the user identification information that identifies the user of the terminal apparatus 40A. Thus, the terminal apparatus 40A is the terminal apparatus corresponding to the user identification information. In this case, the controller 48 of the terminal apparatus 40A causes the UI unit 46 to display a remote control UI based on the remote control UI information. On the other hand, the terminal apparatus 40B is not the terminal apparatus corresponding to the user identification information included in the remote control UI information (NO in S07), the terminal apparatus 40B does not display the remote control UI (S09). Note that device identification information may be used instead of user identification information, and a terminal apparatus corresponding to the device identification information included in the remote control UI information may cause the UI unit 46 to display a remote control UI based on the remote control UI information.

The transmission/reception unit 18 of the information processing apparatus 10 may transmit the remote control UI information only to the terminal apparatus 40A corresponding to the user identification information attached to the image data A, instead of transmitting the remote control UI information to both the terminal apparatuses 40A and 40B. This will be described in detail. First, the transmission/reception unit 18 transmits the user identification information attached to the image data A to both the terminal apparatuses 40A and 40B connected to the network N, in accordance with a broadcast method. In this case, if a terminal apparatus that has received the user identification information is the terminal apparatus corresponding to the user identification information, the terminal apparatus transmits information indicating that the terminal apparatus is the corresponding terminal apparatus to the information processing apparatus 10. The information processing apparatus 10 in turn transmits remote control UI information to the terminal apparatus that has transmitted the information. A description will be given using a specific example. The user identification information attached to the image data A indicates the user of the terminal apparatus 40A. Thus, the terminal apparatus 40A that has received the user identification information transmits, to the information processing apparatus 10, information indicating that the terminal apparatus 40A is the terminal apparatus corresponding to the user identification information. Then, the transmission/reception unit 18 of the information processing apparatus 10 transmits remote control UI information to the terminal apparatus 40A. On the other hand, because the terminal apparatus 40B is not the terminal apparatus corresponding to the user identification information, the transmission/reception unit 18 of the information processing apparatus 10 does not transmit the remote control UI information to the terminal apparatus 40B. As described above, the transmission/reception unit 18 of the information processing apparatus 10 may first transmit the user identification information attached to the image data A to both the terminal apparatuses 40A and 40B, and then transmit remote control UI information to the terminal apparatus 40A upon receiving, from the terminal apparatus 40A corresponding to the user identification information, information indicating that the terminal apparatus 40A is the terminal apparatus corresponding to the user identification information.

In another example, under control of the controller 16, the transmission/reception unit 18 of the information processing apparatus 10 may transmit the remote control UI information to a terminal apparatus associated with the device identification information attached to the image data A, in accordance with association between each device identification information and the corresponding terminal apparatus.

After the remote control UI is displayed on the UI unit 46 of the terminal apparatus 40A in the above-described manner, the user (data provider) of the terminal apparatus 40A enters a command regarding an operation of the projector 30 using the remote control UI displayed on the UI unit 46 (S10). For example, the data provider enters, using the remote control UI, a command such as changing of the page of the image projected by the projector 30.

Upon accepting the command regarding the operation of the projector 30 through the remote control UI, the transmission/reception unit 44 of the terminal apparatus 40A transmits command information representing the command to the information processing apparatus 10 under control of the controller 48 (S11). For example, the controller 48 may include the command information in the remote control UI information as illustrated in FIG. 2B, and the transmission/reception unit 44 may transmit the remote control UI information to the information processing apparatus 10.

The transmission/reception unit 18 of the information processing apparatus 10 receives the command information from the terminal apparatus 40A (S12). The controller 16 of the information processing apparatus 10 controls operation of the projector 30 in accordance with the command represented by the command information. For example, in the case where a command for changing the page is entered by the data provider, the controller 16 changes the page of the image projected by the projector 30 in accordance with the command.

As described above, in the case where image data is specified as a projection target of the projector 30, the terminal apparatus of the data provider is identified based on user identification information attached to the image data, and remote control UI information is provided to the terminal apparatus of the data provider. In this way, operation of the projector 30 from the terminal apparatus is permitted. With this configuration, the data provider is no longer required to give an instruction to the facilitator (user of the information processing apparatus 10) to operate the projector 30. Thus, the projector 30 is easily operated from the terminal apparatus 40A or 40B other than the information processing apparatus 10.

Also, by storing image data in the shared area of the data storage unit 12, and specifying the image data as a projection target using the UI unit 20 of the information processing apparatus 10, remote control UI information is transmitted to the terminal apparatus 40A or 40B corresponding to the image data, and operation of the projector 30 is permitted. Thus, the projector 30 is easily operated from the terminal apparatus 40A or 40B without connecting the terminal apparatus 40A or 40B to the projector 30. For example, even in the case where the projector 30 is used from the terminal apparatus 40A and then is used from the terminal apparatus 40B, disconnection and connection of a cable is no longer needed. Thus, the work load for using the projector 30 is reduced and the work time is shortened.

In the case where the data provider desires to add a projection-target material immediately before or during the meeting, image data is specified as a projection target by storing the image data in the shared area of the data storage unit 12. Thus, it becomes easier to add projection-target image data.

Also, the remote control UI information or the user identification information is transmitted to all terminal apparatuses connected to the network N, in accordance with a broadcast method. In this way, for example, in the case where the same user identification information is associated with multiple terminal apparatuses, the remote control UI information is received by the multiple terminal apparatuses and operation of the projector 30 from the multiple terminal apparatuses is permitted. For example, it is assumed that the data provider has brought a notebook PC (for example, the terminal apparatus 40A) and a smartphone (for example, the terminal apparatus 40B) to the meeting, and has connected both of them to the network N. The notebook PC and the smartphone are associated with the same user identification information. In this case, both the notebook PC (the terminal apparatus 40A) and the smartphone (the terminal apparatus 40B) receive the remote control UI information, and the corresponding remote control UI is displayed on both the terminal apparatuses. The data provider is permitted to operate the projector 30 from both the terminal apparatuses. For example, even in the case where projection-target image data is stored in the notebook PC (the terminal apparatus 40A) and the projection-target image data is transmitted from the notebook PC to the information processing apparatus 10, the data provider is permitted to operate the projector 30 from the smartphone (the terminal apparatus 40B) as well as the notebook PC. In this way, operation from multiple terminal apparatuses is permitted, which thus improves the convenience of the data provider.

Further, by employing a broadcast method, the remote control UI information may be provided to a terminal apparatus that is not connected to the network N initially but is connected to the network N later. For example, even in the case where a notebook PC (e.g., the terminal apparatus 40A) alone is connected to the network N initially and a smartphone (e.g., the terminal apparatus 40B) is connected to the network N later, the remote control UI information may be provided also to the smartphone. For example, even in the case where projection-target image data is transmitted from the notebook PC (the terminal apparatus 40A) to the information processing apparatus 10, if the smartphone (the terminal apparatus 40B) is connected to the network N when the remote control UI information is transmitted by the information processing apparatus 10, the remote control UI information may be transmitted also to the smartphone. In the case where the same user identification information is given to the notebook PC and the smartphone, operation of the projector 30 from the smartphone is also permitted as in the above-described case.

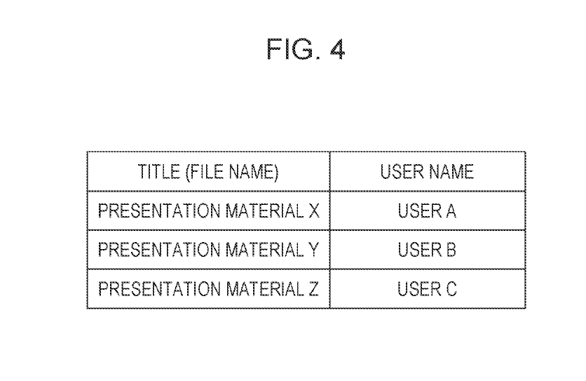

Next, a modification will be described. In a modification, for example, schedule data which represents an order in which images based on pieces of image data are to be projected is stored in the data storage unit 12 of the information processing apparatus 10. This schedule data represents, for example, a presentation order table. FIG. 4 illustrates an example of the order table. In this order table, a title (or data name) of a presentation material is associated with a user name (user identification information). Data of this order table is stored in the data storage unit 12. Pieces of data of presentation materials X, Y, and Z are stored in the data storage unit 12. A user associated with a presentation material is, for example, a provider or user of the presentation material. Note that the title (or data name) of a presentation material corresponds to an example of a unique identifier. Once the facilitator operates the UI unit 20 so as to specify the title of a presentation material to be projected, the controller 16 identifies the user associated with the title specified as the projection target, by referring to data of the order table stored in the data storage unit 12, and controls the transmission/reception unit 18 to transmit remote control UI information to the terminal apparatus of the user. For example, in the case where the presentation material X is specified as the projection target, the controller 16 controls the transmission/reception unit 18 to transmit remote control UI information to the terminal apparatus of the user A associated with the presentation material X. For example, the information processing apparatus 10 transmits the remote control UI information to terminal apparatuses in accordance with the above-described broadcast method. Benefits similar to those of the above-described exemplary embodiment are obtained also in this modification.

In the exemplary embodiment and modification described above, examples described below may be carried out.

For example, in the case where remote control UI information including command information is transmitted to the information processing apparatus 10 from the terminal apparatus 40A, the controller 16 of the information processing apparatus 10 may perform the following processing. If data identification information included in the remote control UI information matches data identification information of image data specified as the projection target of the projector 30, the controller 16 may permit the user to operate the projection-target image data from the terminal apparatus 40A. Specifically, the controller 16 identifies operation-target image data on the basis of the data identification information included in the remote control UI information. If the operation-target image data matches the image data specified as the projection target of the projector 30, the controller 16 may permit the user to operate the projector 30 from the terminal apparatus 40A. In this way, mismatch between the operation-target image data and the projection-target image data is avoided and erroneous operation of the projection-target image data is avoided or reduced. In another example, in the case where the user identification information (or device identification information) included in the remote control UI information matches the user identification information (or device identification information) attached to the image data specified as the projection target of the projector 30, the controller 16 may permit the user to operate the image data specified as the projection target of the projector 30 from the terminal apparatus 40A.

Also, an apparatus that is not directly connected to the network N but is connected to a terminal apparatus connected to the network N may receive remote control UI information transmitted to the terminal apparatus and display a remote control UI. For example, suppose that the terminal apparatus 40A is connected to the network N and another terminal apparatus (for example, a smartphone) is, directly or via another communication channel, connected to the terminal apparatus 40A instead of being directly connected to the network N. In this case, the smartphone may acquire the remote control UI information received by the terminal apparatus 40A and display a remote control UI based on the remote control UI information. In this way, a permission to operate the projector 30 may be given to an apparatus not directly connected to the network N.

Also, the terminal apparatuses 40A and 40B may transmit another projection-target image data to the information processing apparatus 10 in the background while an image is being projected by the projector 30. With this configuration, the time taken to start projection is shortened, compared with the case where image data is transmitted to the information processing apparatus 10 immediately before an image is projected.

Also, the terminal apparatuses 40A and 40B may divide projection-target image data into multiple data portions, and sequentially transmit the data portions to the information processing apparatus 10. The controller 16 of the information processing apparatus 10 receives the data portions, and causes the projector 30 to project images based on the data portions. For example, the terminal apparatuses 40A and 40B divide image data of multiple pages into image data portions of individual pages, and sequentially transmit the image data portions of individual pages to the information processing apparatus 10. The controller 16 of the information processing apparatus 10 receives the image data portions of individual pages, and causes the projector 30 to project the images of the individual pages in accordance with a command entered using a remote control UI. A description will be given using a specific example. Upon receiving an image data portion of the first page from the terminal apparatus, the controller 16 of the information processing apparatus 10 causes the projector 30 to project an image of the first page. While the image of the first page is being projected, the information processing apparatus 10 receives an image data portion of the second page from the terminal apparatus. By dividing projection-target image data into data portions, sequentially transmitting and receiving the data portions, and sequentially projecting images based on the data portions, the time taken to start projection is shortened, compared with the case where projection processing is started after the entire data has been transmitted and received.

Also, group identification information that identifies a group to which a user belong may be associated with each of the information processing apparatus 10 and the terminal apparatuses 40A and 40B so as to allow the information processing apparatus 10 and the terminal apparatuses 40A and 40B to mutually identify the groups to which their users belong. For example, the information processing apparatus 10 may associate each of the information processing apparatus 10 and the terminal apparatuses 40A and 40B with group identification information that identifies a group to which the user belongs so as to distinguish each group. This configuration allows, even in the case where apparatuses belonging to different groups are connected to the network N, an apparatus belonging to one group to recognize apparatuses belonging to the same group. Accordingly, in the case where multiple groups are having meetings using the same network N, each apparatus identifies a group to which it belongs and identifies a corresponding meeting, and thus interference from another group (meeting) is avoided. For example, the information processing apparatus 10 permits access from terminal apparatuses belonging to the same group and prohibits access from terminal apparatuses belonging to other groups. With this configuration, remote control UI information related to projection-target image data stored in the data storage unit 12 of the information processing apparatus 10 is not transmitted to terminal apparatuses of other groups. Accordingly, interference regarding remote control operations between different groups is avoided.

Remote control UI information may be pre-stored in the terminal apparatuses 40A and 40B. The information processing apparatus 10 may transmit permission information which represents a permission to use the remote control UI information to the terminal apparatus 40A corresponding to projection-target image data. The terminal apparatus 40A that has received the permission information may be permitted to use a remote control UI. With this configuration, the terminal apparatus 40B that has not received the permission information is prohibited from using the remote control UI, and only the terminal apparatus 40A that has received the permission information is permitted to use the remote control UI.

After the terminal apparatus 40A finishes using the remote control UI, the remote control UI information may be automatically deleted from the terminal apparatus 40A. For example, in the case where image data B transmitted from the terminal apparatus 40B is newly specified as the projection target in the information processing apparatus 10, user identification information associated with the image data B or remote control UI information including the user identification information is transmitted from the information processing apparatus 10 to the terminal apparatuses 40A and 40B in accordance with a broadcast method. At this time, because the terminal apparatus 40A is not the terminal apparatus corresponding to the image data B, the controller 48 of the terminal apparatus 40A may delete the remote control UI information stored in the terminal apparatus 40A. With this configuration, in the case where the image data B is newly specified as the projection target, the remote control UI information is automatically deleted from the terminal apparatus 40A which has finished using the projector 30. Thus, only a person who has provided the image data B is permitted to use the remote control UI. In this way, the terminal apparatuses 40A and 40B each may delete the remote control UI information in the case where the terminal apparatus is not the terminal apparatus corresponding to the user identification information transmitted from the information processing apparatus 10. Because the terminal apparatus that no longer needs the remote control UI deletes the remote control UI information, interference regarding remote control operations between terminal apparatuses is avoided. For example, only a presenter at the meeting is permitted to use the remote control UI, and interference regarding remote control operations between terminal apparatuses is avoided.

Alternatively, a schedule which represents an order in which images based on pieces of image data are to be projected may be predetermined, and the information processing apparatus 10 may specify projection-target image data in accordance with the schedule and transmit remote control UI information to the terminal apparatus corresponding to the image data.

Alternatively, the information processing apparatus 10 may transmit the projection-target image data A along with the remote control UI information to the terminal apparatus 40A. The controller 48 of the terminal apparatus 40A may cause the UI unit 46 to display the remote control UI, and further to display an image based on the projection-target image data A. The user (data provider) is permitted to perform an operation while viewing the image displayed on the terminal apparatus 40A, which thus improves the convenience of the user. At this time, in response to an operation performed on the remote control UI, the controller 48 of the terminal apparatus 40A may switch the image displayed on the UI unit 46 in accordance with the image data A. Because the image projected by the projector 30 is operated in response to an operation performed on the remote control UI, an operation performed on the image projected by the projector 30 and the operation performed on the image displayed on the terminal apparatus 40A are coordinated. With this configuration, the convenience of the user is further improved.

Note that the information processing apparatus 10 may be built into the projector 30. In this case, the projector 30 is connected to the network N, receives image data from the terminal apparatuses 40A and 40B, and projects an image based on the image data.

The above-described information processing apparatus 10 is realized through cooperation of hardware resources and software, for example. Specifically, the information processing apparatus 10 includes a processor (not illustrated) such as a central processing unit (CPU). Functions of the management unit 14, the controller 16, and the transmission/reception unit 18 are realized as a result of the processor reading out and executing a program stored in a storage device (not illustrated). The program is stored in the storage device via a storage medium, such as a compact disc (CD) or digital versatile disc (DVD), or via a communication channel, such as a network.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that stores data including an identifier of another apparatus or an identifier of a user of the other apparatus;
a display that displays an image based on the data;
a transmission unit that transmits, in a case where the data is specified as a display target, information related to a display operation to be performed on the data to the other apparatus identified by the identifier of the other apparatus or by the identifier of the user of the other apparatus;
a reception unit that receives, from the other apparatus, an operation command corresponding to a display operation to be performed on the data; and
a display operation unit that operates the displayed image based on the data, in accordance with the received operation command.

2. The information processing apparatus according to claim 1, wherein
the display is a projector,
the operation command is a command for changing the page of the image, and
the display operation unit changes the page of the image projected based on the data by the projector, when the operation command for changing the page of the image is received.

3. An information processing system, comprising:
an information processing apparatus; and
a terminal,
the information processing apparatus including
a memory that stores data including an identifier of the terminal or an identifier of a user of the terminal,
a first display that displays an image based on the data,
a first transmission unit that transmits, in a case where the data is specified as a display target, information related to a display operation to be performed on the data to the terminal identified by the identifier of the terminal or by the identifier of the user of the terminal,
a first reception unit that receives, from the terminal, an operation command corresponding to a display operation to be performed on the data, and
a first display operation unit that operates the displayed image based on the data, in accordance with the received operation command, and
the terminal including
a second reception unit that receives, from the information processing apparatus, the information related to a display operation to be performed on the data,
a second display that displays the received information related to a display operation,
an accepting unit that accepts an operation command entered by a user using the displayed information related to a display operation, and
a second transmission unit that transmits the accepted operation command to the information processing apparatus.

4. The information processing system according to claim 3, wherein
the first display is a projector,
the second display displays a user interface used to operate the displayed image based on the data,
the accepting unit accepts an operation command for changing the page of the image, entered by the user through the user interface, and
the display operation unit changes the page of the image projected based on the data by the projector, when the operation command for changing the page of the image is received.

5. The information processing system according to claim 3, wherein
the information related to a display operation to be performed on the data includes an identifier of a terminal, and
in a case where the identifier of a terminal included in the received information related to a display operation to be performed on the data is not the identifier of the terminal, the second display does not display the information related to a display operation.

6. A non-transitory computer readable medium storing a program causing a computer to execute a process for information processing, the process comprising:
storing data including an identifier of another apparatus or an identifier of a user of the other apparatus;
displaying an image based on the data;
transmitting, in a case where the data is specified as a display target, information related to a display operation to be performed on the data to the other apparatus identified by the identifier of the other apparatus or by the identifier of the user of the other apparatus;
receiving, from the other apparatus, an operation command corresponding to a display operation to be performed on the data; and
operating the displayed image based on the data, in accordance with the received operation command.
